(19) United States
(12) Patent Application Publication
(10) Pub. No.: US 2017/0012516 A1
(43) Pub. Date: Jan. 12, 2017

(54) VIBRATING MOTOR

(71) Applicants: Hongfu Xu, Shenzhen (CN); Zhilin Chai, Shenzhen (CN); Na Wu, Shenzhen (CN)

(72) Inventors: Hongfu Xu, Shenzhen (CN); Zhilin Chai, Shenzhen (CN); Na Wu, Shenzhen (CN)

(73) Assignee: AAC Technologies Pte, Ltd., Singapore city (SG)

(21) Appl. No.: 15/060,632

(22) Filed: Mar. 4, 2016

(30) Foreign Application Priority Data
Jul. 10, 2015 (CN) 201520501281.9

(51) Int. Cl. H02K 33/00; H02K 11/30

(52) U.S. Cl. CPC H02K 33/00; H02K 11/30

(57) ABSTRACT

A vibrating motor is provided in the present disclosure. The vibrating motor includes a housing providing a receiving cavity, a PCB fixed on the housing, a coil received in the receiving cavity and a magnetic assembly opposite to and keeping a distance from the coil. The coil includes a lead wire; the housing includes a base with a plurality of sidewalls. One of the sidewalls adjacent to the coil provides a supporting platform protruding from the receiving cavity. The PCB is positioned on the supporting platform. The lead wire extends to the supporting platform, and electrically connected to the PCB.

### FIELD OF THE DISCLOSURE

The present disclosure generally relates to vibrator technologies and, more particularly, to a vibrating motor for providing vibration feedback.

### BACKGROUND

Portable consumer products, such as mobile phones, handheld game players, navigation devices and portable multi-media players, generally include vibrating motors for generating vibration feedback. For example, the vibrating motor may be used in a mobile phone for providing vibrating system feedback while receiving an incoming call, or used in a portable multi-media player for providing haptic feedback.

In a related vibrating motor, a printed circuit board (PCB) is located on a bottom plate, and a coil is positioned on a top of the PCB. The coil is electrically connected to an external circuit through the PCB. With this configuration, the PCB is led out from the bottom plate of the vibrating motor; however, in some circumstances, the PCB may need to be led out form a side of the vibrating motor to meet some special requirement of products.

Therefore, it is desired to provide a vibrating motor to overcome the aforesaid problems.

### BRIEF DESCRIPTION OF THE DRAWINGS

Many aspects of the embodiments can be better understood with reference to the following drawings. The components in the drawing are not necessarily drawn to scale, the emphasis instead being placed upon clearly illustrating the principles of the present disclosure. Moreover, in the drawings, like reference numerals designate corresponding parts throughout the several views.

FIG. 1 schematically illustrates an exploded view of a vibrating motor according to an exemplary embodiment of the present disclosure.

FIG. 2 schematically illustrates a planar, partly assembled view of the vibrating motor in FIG. 1.

### DETAILED DESCRIPTION

The present disclosure will be described in detail below with reference to the attached drawings and embodiments thereof.

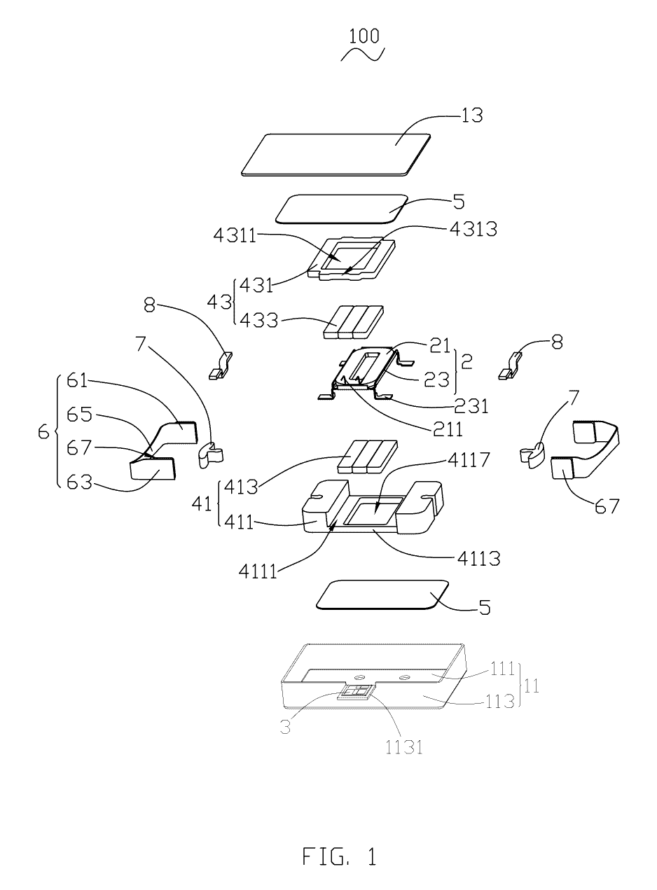

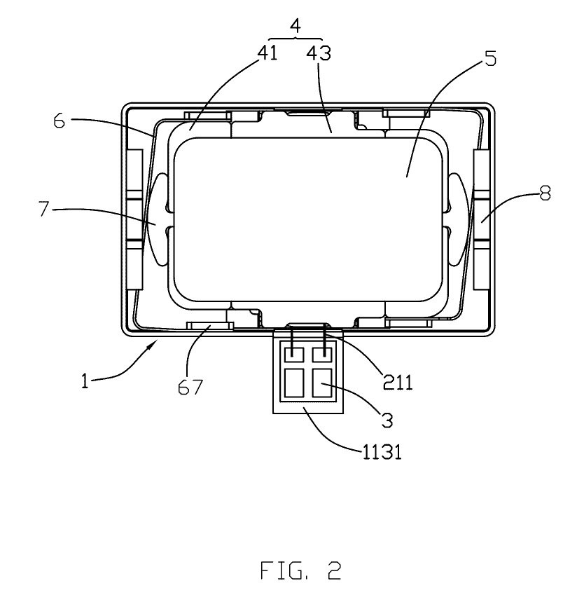

Referring to FIGS. 1-2, a vibrating motor 100 according to an exemplary embodiment of the present disclosure is shown. The vibrating motor 100 includes a fixed unit and a vibrating unit.

The fixed unit includes a housing 1 for providing a receiving cavity, a coil assembly 2 located in the receiving cavity, and a PCB 3 fixed on the housing 1. The coil assembly 2 is electrically connected to an external circuit through the PCB 3 so as to enable electrical signals to be transmitted therebetween.

Specifically, the housing 1 includes a base 11 and a cover 13, the cover 13 covers the base 11 and cooperates with the base 11 to form the receiving cavity. The base 11 includes a bottom plate 111 and a plurality of sidewalls 113 perpendicular to the bottom plate 111. For example, the bottom plate 111 is a rectangular plate with four edges, and the base 11 includes four sidewalls 113 perpendicularly extending from the four edges of the bottom 111. One of the sidewalls 113, which is adjacent to the coil assembly 2, includes a supporting platform 1131 protruding perpendicularly from the receiving cavity. The supporting platform 1131 may be a rectangular plate parallel to the bottom plate 111, and is configured for supporting and fixing the PCB 3.

The coil assembly 2 includes a coil 21 and a support 23 supporting the coil 21. Both the coil 21 and the support 23 are received in the receiving cavity of the housing 1. The coil 21 includes a lead wire 211 electrically connected to the PCB 3. The lead wire 211 is led out from an end of the coil 21 adjacent to the supporting platform 1131. In addition, the lead wire 211 is attached to the sidewall 113 having the supporting platform 1131, and the lead wire 211 further extends to the supporting platform 1131, and is fixed to the PCB 3 by spot welding.

The support 23 includes a plurality of supporting parts 231 extending from the corners of the support 23; and the support 23 is fixed to the bottom plate 111 of the base 11 via the supporting parts 231 thereof. Preferably, the supporting parts 231 are fixed to the bottom plate 111 by welding.

The PCB 3 is positioned on the supporting platform 1131. A shape of the PCB 3 is coincident with that of the supporting platform 1131, and a size of the PCB 3 is substantially smaller than that of the supporting platform 1131.

The vibrating unit is received in the receiving cavity of the housing 1, and includes a magnetic assembly 4, a pole plate 5 positioned under the magnet assembly 4 and a pair of elastic parts 6 for suspending the magnetic assembly 4 in the receiving cavity.

The magnetic assembly 4 includes a first magnetic module 41 and a second magnetic module 43 disposed opposite the first magnetic module 41. The first magnetic module 41 includes a first mass member 411 and a first magnet 413 received in the first mass member 411. Moreover, the first mass member 411 includes a groove 4111 formed at a central of a main body thereof. A first through hole 4117 is formed in and runs through a bottom 4113 of the groove 4111, and the first magnet 413 is received in the first through hole 4117.

The second magnetic module 43 includes a second mass member 431 and a second magnet 433. A second through hole 4311 is formed at a central part of the second mass member 431, and the second magnet 433 is received in the second through hole 4311. Moreover, the second mass member 431 may be received in the groove 4111 of the first mass member 411, and contacts against the main body of the first mass member 411.

In particular, the second mass member 431 of the magnetic assembly 4 is spaced from the bottom 4113 of the groove 4111. With this configuration, the first magnet 431 and the second magnet 433 are disposed opposite to and keep a distance from each other.

In the present embodiment, the coil 21 of the coil assembly 2 is supported by the support 23 and is suspended between the first magnetic module 41 and the second magnetic module 43. Specifically, a gap exists between the second mass member 431 and the bottom 4113 of the groove 4111 of the first mass member 411. The coil 21 is suspended in the gap, and opposite to both the first magnetic module 41 and the second magnetic module 43 at a certain distance.

Moreover, a protecting part 4313 may be formed in the second mass member 431 to protect the lead wire 211 of the coil 21 while the vibrating motor 100 is vibrating or suffers falling. Specifically, the protecting part 4313 has a concave structure, and is concaved at a side of the second mass member 431 corresponding to the lead wire 211.

The pole plate 5 is made of magnetic material. In the present embodiment, the pole plate 5 is separated into a pair of pole units which are respectively positioned on a top surface and a bottom surface of the magnetic assembly 4. The pole plate 5 effectively shields a magnetic field within the vibrating motor 100 to weaken the magnetic intensity at a surface of the housing 1, thus a magnetic flux leakage phenomenon of the vibrating motor 100 can be reduced.

Each of the elastic part 6 includes a first connecting part 61, a second connecting part 63 and a third connecting part 65 connecting to both the first connecting part 61 and the second connecting part 63. In the present embodiment, the first connecting part 61 and the second connecting part 63 are respectively connected to the housing 1 and an end of the first mass member 411, and the third connecting part 65 is spaced from the housing 1. In order to ensure the elastic part 6 to be fixed on the housing 1 and/or on the first mass member 411, at least one gasket 67 may be provided and positioned on the first connecting part 61 and/or the second connecting part 63.

The vibrating motor 100 further includes a damping member 7 and a blocking member 8. The damping member 7 is located between the elastic part 6 and the magnetic assembly 4; the blocking member 8 is located between the elastic part 6 and the base 11. The damping member 7 may perform elastic deformation to depress the relative motion between the magnetic assembly 4 and the elastic part 6, thus preventing the vibrating motor 100 from suffering impairment. The blocking member 8 is fixed to the bottom plate 111 of the base 11, and configured for avoiding collision between the elastic part 6 and the base 11.

Alternatively, in another embodiment, roles of the coil assembly 2 and the magnetic assembly 4 can be reversed. For example, the coil assembly 2 can be a part of the vibrating unit, while the magnetic assembly 4 can be a part of the fixed unit.

In the present disclosure, a supporting platform 1131 extends perpendicularly from a sidewall 113 of the base 11 corresponding to the coil 2, and is provided to support the PCB 3, and the lead wire 211 connected to the coil 21 is attached to the sidewall 113 and fixed to the PCB 3 supported by the supporting platform 1131. With this configuration, the PCB 3 can be led out from a side of the vibrating motor 100 to meet the product design requirement.

It is to be understood, however, that even though numerous characteristics and advantages of the present embodiments have been set forth in the foregoing description, together with details of the structures and functions of the embodiments, the disclosure is illustrative only, and changes may be made in detail, especially in matters of shape, size, and arrangement of parts within the principles of the invention to the full extent indicated by the broad general meaning of the terms in which the appended claims are expressed.

What is claimed is:

1. A vibrating motor, comprising:
a housing providing a receiving cavity and comprising a base with a plurality of sidewalls;
a print circuit board (PCB) fixed on the housing;
a coil received in the receiving cavity and comprising a lead wire; and
a magnetic assembly opposite to and keeping a distance from the coil;
wherein one of the sidewalls adjacent to the coil provides a supporting platform protruding from the receiving cavity, the PCB is positioned on the supporting platform, the lead wire extends to the supporting platform, and is electrically connected to the PCB.

2. The vibrating motor as described in claim 1, wherein the lead wire is attached to the sidewall providing the supporting platform, and is fixed to the PCB by spot welding.

3. The vibrating motor as described in claim 1, wherein the magnetic assembly comprises a first magnetic module and a second magnetic module disposed opposite to the first magnetic module.

4. The vibrating motor as described in claim 3, wherein the first magnetic module comprises a first mass member and a first magnet received in the first mass member, and the first mass member comprises a groove formed at a central of a main body thereof.

5. The vibrating motor as described in claim 4, wherein the bottom comprises a first through hole for receiving the first magnet.

6. The vibrating motor as described in claim 5, wherein the second magnetic module comprises a second mass member and a second magnet, the second mass member comprises a second through hole for receiving the second magnet.

7. The vibrating motor as described in claim 6, wherein the second mass member is received in the groove of the first mass member, and spaced from the bottom of the groove.

8. The vibrating motor as described in claim 7, wherein the coil is suspended between the bottom of the groove of the first mass member and the second mass member, and opposite to both the first magnetic module and the second magnetic module at a certain distance.

9. The vibrating motor as described in claim 6, wherein the second mass member comprises a protecting part concaved at a side of the second mass member to protect the lead wire.

10. The vibrating motor as described in claim 1, wherein a shape of the PCB is coincident with that of the supporting platform and a size of the PCB is smaller than that of the supporting platform.

11. The vibrating motor as described in claim 1, wherein the supporting platform is a rectangular plate parallel to the bottom plate.
